(19) United States
(12) Patent Application Publication
(10) Pub. No.: US 2026/0338538 A1
(43) Pub. Date: Oct. 29, 2026

(54) MEASUREMENT DEVICE AND MEASUREMENT METHOD

(71) Applicant: Lasertec Corporation, Yokohama (JP)

(72) Inventor: Yuta SUGIHARA, Yokohama (JP)

(21) Appl. No.: 19/576,583

(22) Filed: Mar. 24, 2026

(30) Foreign Application Priority Data
Mar. 24, 2025 (JP) 2025-048157

(51) Int. Cl. G01B 11/02; G01S 11/12

(52) U.S. Cl. CPC G01B 11/02; G01S 11/12

(57) ABSTRACT

A measuring device controls a height position between a target object and a first focusing point, detects return light at a first and a second positions, acquires first intensity information indicating a relationship between the height position and first detected intensity at the first position, and second intensity information indicating a relationship between the height position and second detected intensity at the second position, acquires relationship information indicating a relationship between the height position and a parameter based on a comparison between the first and the second intensity information, and obtains surface height information on a test sample by using a first detection result obtained by detecting, when the test sample is irradiated with the illumination light at a plurality of height positions, the return light at a third position, a second detection result obtained by detecting the return light at a fourth position, and the relationship information.

### INCORPORATION BY REFERENCE

This application is based upon and claims the benefit of priority from Japanese Patent Application No. 2025-048157, filed on Mar. 24, 2025, the disclosure of which is incorporated herein in its entirety by reference for all purposes.

### BACKGROUND

The present disclosure relates to a measuring device and a measuring method.

Various devices for measuring the three-dimensional shape of an uneven measurement surface of a sample have been proposed as in the past (e.g., Patent Literature 1).

[Patent Literature 1] Japanese Unexamined Patent Application Publication No. 2020-64127

### SUMMARY

In such measuring devices, it is desired to shorten the measurement time while maintaining the measurement accuracy.

The present disclosure has been made in view of the above-described circumstances, and an object thereof is to provide a measuring device and a measuring method capable of quickly measuring the shape of a measurement surface of a sample.

A measuring device according to the present disclosure includes: an illumination optical system configured to apply illumination light to a target object; an image-forming optical system configured to concentrating return light from the target object based on the illumination light; a position control unit configured to control a height position, the height position being a relative position between the target object and a first focusing point of the illumination light on the target object by the illumination optical system in a height direction; a detection unit configured to detect, when a preparation sample is irradiated with the illumination light at a plurality of height positions different from each other at a predetermined position of the preparation sample, the return light at a first position in the image-forming optical system and at a second position a first optical distance away from the first potion, and acquire first intensity information indicating a relationship between the height position and first detected intensity at the first position and second intensity information indicating a relationship between the height position and second detected intensity at the second position, in which the preparation sample is the target object; an acquisition unit configured to acquire relationship information indicating a relationship between the height position and a parameter based on a comparison between the first intensity information and the second intensity information; and a measuring unit configured to obtain surface height information at a plurality of measurement points on a test sample by using a first detection result obtained by detecting, when the test sample is irradiated with the illumination light at a plurality of height positions while setting a height position for the test sample to a predetermined reference position, the return light at a third position in the image-forming optical system, a second detection result obtained by detecting the return light at a fourth position a second optical distance away from the third position, and the relationship information, in which the test sample is the target object.

A measuring method according to the present disclosure includes, by using a measuring device including an illumination optical system configured to apply illumination light to a target object, and an image-forming optical system configured to concentrating return light from the target object based on the illumination light, controlling a height position, the height position being a relative position between the target object and a first focusing point of the illumination light on the target object by the illumination optical system in a height direction; detecting, when a preparation sample is irradiated with the illumination light at a plurality of height positions different from each other at a predetermined position of the preparation sample, the return light at a first position in the image-forming optical system and at a second position a predetermined optical distance away from the first potion, and acquiring first intensity information indicating a relationship between the height position and first detected intensity at the first position and second intensity information indicating a relationship between the height position and second detected intensity at the second position, in which the preparation sample is the target object; acquiring relationship information indicating a relationship between the height position and a parameter based on a comparison between the first intensity information and the second intensity information; and obtaining surface height information at a plurality of measurement points on a test sample by using a first detection result obtained by detecting, when the test sample is irradiated with the illumination light at a plurality of height positions while setting a height position for the test sample to a predetermined reference position, the return light at a third position in the image-forming optical system, a second detection result obtained by detecting the return light at a fourth position a predetermined optical distance away from the third position, and the relationship information, in which the test sample is the target object.

According to the present disclosure, it is possible to quickly measure the shape of a measurement surface of a sample.

The above and other objects, features and advantages of the present disclosure will become more fully understood from the detailed description given hereinbelow and the accompanying drawings.

### BRIEF DESCRIPTION OF DRAWINGS

FIG. 1 schematically shows a configuration of a measuring device according to a first embodiment;

FIG. 2 is a diagram for explaining “Z scanning” in a preparation stage;

FIG. 3 is a graph schematically showing a relationship between detected intensity (luminance) of return light L2 and a height position (Z) acquired in the preparation stage;

FIG. 4 shows a relationship between a parameter(S) based on a comparison between first intensity information (detection signal DET1) and second intensity information (detection signal DET2) shown in FIG. 3 and a height position (Z);

FIG. 5 shows a relationship between an I-Z curve on an image-forming surface conjugate with a sample focusing point and an I-Z curve of a first position and a second position when the first position is a rear focal position and the second position is a front focal position;

FIG. 6 shows a relationship between an I-Z curve on an image-forming surface conjugate with a sample focusing point and an I-Z curve of a first position and a second position when both the first position and the second position are rear focal positions;

FIG. 7 shows a relationship between an I-Z curve on an image-forming surface conjugate with a sample focusing point and an I-Z curve of a first position and a second position when both the first position and the second position are front focal positions;

FIG. 8 schematically shows how two-dimensional scanning is performed on a test sample by illumination light on an XY plane;

FIG. 9 schematically shows how a relative position of a region on a test sample on which an image is formed in a detector in a test sample is changed when two-dimensional scanning is performed as shown in FIG. 8;

FIG. 10 is a graph for explaining a relationship between a measurement surface of the test sample and the focusing point (image-forming surface) of an image-forming optical system when a use region 1 shown in FIG. 4 is used as relationship information;

FIG. 11 shows a relationship between a measurement surface of the test sample and the focusing point (image-forming surface) of an image-forming optical system when a use region 1 shown in FIG. 4 is used as relationship information;

FIG. 12 is a flowchart for explaining a measurement method according to the first embodiment;

FIG. 13 schematically shows ta configuration of a measuring device according to a second embodiment; and

FIG. 14 is a schematic diagram showing a change of a focal point FP1 in a measuring device according to a third embodiment.

### DESCRIPTION OF EMBODIMENTS

Embodiments according to the present disclosure will be described hereinafter with reference to the drawings. In order to clarify the explanation, the following description and the drawings are partly omitted and simplified as appropriate. Further, the same elements are assigned the same reference numerals (or symbols) throughout the drawings, and redundant descriptions will be omitted as appropriate. Note that the following description is intended to show preferred embodiments according to the present disclosure, and the scope of the present disclosure is not limited to the embodiments described below.

An embodiment relates to a measuring device for measuring the three-dimensional shape of an uneven measurement surface of a target object. The measuring device according to the embodiment includes an illumination optical system for applying illumination light to a target object, and an image-forming optical system for concentrating return light from the target object which is based on the illumination light.

### First Embodiment

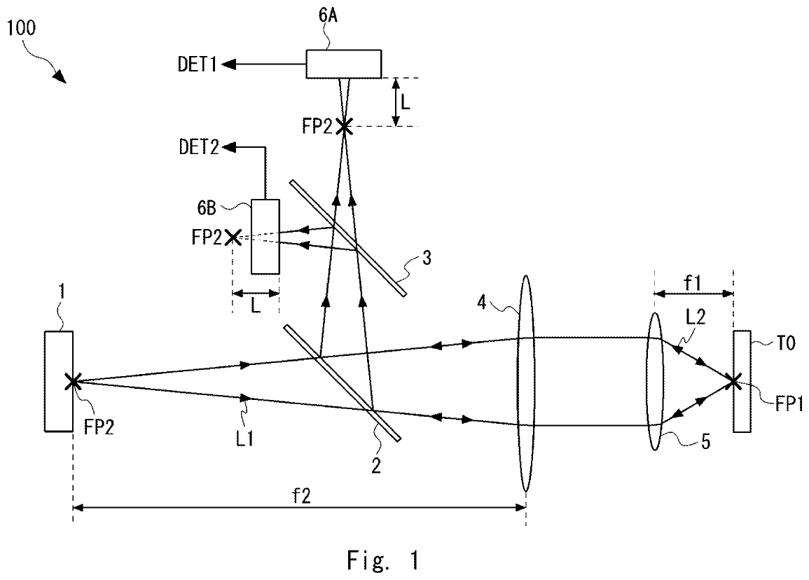

FIG. 1 schematically shows a configuration of a measuring device according to a first embodiment. A measuring device 100 includes, as its main components, a light source 1, beam splitters 2 and 3, a lens 4, an objective lens 5, and detectors 6A and 6B. In the first embodiment, two detectors 6A and 6B are used as the detection unit. Hereinafter, the two detectors 6A and 6B are also collectively referred to as a detection unit(s) 6. In the following description, the optical axis direction of the optical system is defined as a Z direction, and directions perpendicular to the optical axis are defined XY directions.

The light source 1 emits illumination light L1 for irradiating a target object T0 therewith. The light source 1 is, for example, a laser light source such as a laser diode. In FIG. 1, the paths of the light in the measuring device 100 are indicated by arrows. The illumination light L1 is applied to the target object T0 through the beam splitter 2, the lens 4, and the objective lens 5. The light emitted from the light source 1 may be emitted as the illumination light L1 through a slit or a pinhole.

The beam splitter 2 is, for example, a half-silvered mirror and lets a part of the light incident thereon pass therethrough. The illumination light L1 that has passed through the beam splitter 2 enters the objective lens 5. The objective lens 5 concentrates the illumination light L1, which has entered therein, and applies the concentrated light to the target object T0. In this way, the illumination light L1 emitted from the light source 1 forms an image on the target object T0. In the case where the light source 1 is a point light source, a point-like spot is formed on the target object T0. That is, the beam splitter 2, the lens 4, and the objective lens 5 can be considered to be an “illumination optical system”.

The objective lens 5 is configured to be able to be driven along the irradiation direction (Z direction) of the illumination light L1 to the target object T0 so as to control the focusing point (focal point FP1) with respect to the target object T0. The focal length of the objective lens 5 is represented by f1. The control unit for driving the objective lens 5 in the Z direction can function as an example of a “position control unit” for controlling the height position, which is the relative position between the target object T0 and the focusing point by the illumination optical system in the height direction. In the following description, an example of the control of the height position by changing the position of the objective lens 5 will be described.

The return light L2 from the target object T0 based on the illumination light L1 enters the beam splitter 2 through the objective lens 5 and the lens 4. The return light L2 could be reflected light that is generated as the target object T0 is illuminated with the illumination light L1. Note that the return light L2 may be any of various light rays that is generated as the target object T0 is illuminated with the illumination light L1, such as reflected light, transmitted light, scattered light, and fluorescence.

The return light L2 that has entered the objective lens 5 from the target object T0 propagates to the beam splitter 2 through the same optical path as that of the illumination light L1. The beam splitter 2 reflects a part of the return light L2, which has entered the beam splitter 2, in the direction toward the beam splitter 3. The beam splitter 3 splits (i.e., divides) the return light L2, which has entered the beam splitter 3, toward the detectors 6A and 6B. That is, the objective lens 5, the lens 4, the beam splitter 2, and the beam splitter 3 can be considered to be an “image-forming optical system” that concentrates the return light L2 from the target object T0 based on the illumination light L1 and guides the concentrated return light L2 to the detection unit 6. In the first embodiment, the optical system including the illumination optical system for applying the illumination light L1 emitted from the light source 1 to the target object T0 and the image-forming optical system for guiding the return light L2 coming from the target object T0 to the detection unit 6 may constitute a confocal optical system.

Note that although it is not shown here, the target object T0 is placed on a stage. The stage is, for example, a movable stage such as a rotating stage or an XYZ stage. The illuminated position on the target object T0 is changed by driving the stage.

The detection unit 6 detects return light L2 coming from a plurality of measurement positions on the target object T0, which are irradiation positions of the illumination light L1. In other words, the stage can function as an example of a “scanning control unit” for moving the region on the target object T0 where an image is formed by the detection unit 6 relative to the target object T0. Note that how the scanning control unit is configured is not limited to any particular ways as long as the relative position of the target object T0 and the region on the target object T0 where an image is formed by the detection unit 6 can be controlled. For example, the target object T0 may be two-dimensionally scanned by the illumination light by using a galvano-mirror or the like.

Further, by driving the stage in the Z direction (optical axis direction), the distance between the objective lens 5 and the target object T0 changes. In this way, the focusing point can be adjusted, and the target object T0 can be moved to the in-focus point. The stage may function as another example of the above-described “position control unit” for controlling the height position. The target object T0 may be held by a holding part embodied by a pinching mechanism, a robot arm, or the like in addition to the stage. That is, the stage is an example of the holding part for holding the target object T0.

Note that the focal point FP2 of the lens 4 coincides with the exit point of the illumination light L1 from the light source 1. The focal length of the lens 4 is represented by f2. The focal point FP2 of the return light L2 reflected by the beam splitter 2 is a position conjugate with the exit point of the illumination light L1 from the light source 1.

The detectors 6A and 6B are arranged in such a manner that the optical distances from the beam splitter 3 to them are different from each other. In this example, the optical distance between the detector 6A and the beam splitter 3 is longer than the optical distance between the detector 6B and the beam splitter 3. That is, the detector 6A is disposed at a position further than the focal point FP2 of the return light L2 by an optical distance L (hereinafter also referred to as the “rear focal position”). The rear focal position is an example of the “first position”. Further, the detector 6B is disposed at a position closer than the focal point FP2 of the return light L2 by an optical distance L (hereinafter also referred to as the “front focal position”). The front focal position is an example of the “second position”.

The detector 6A outputs a detection signal DET1 corresponding to the detected intensity (luminance) of the return light L2 from the target object T0. Further, the detector 6B outputs a detection signal DET2 corresponding to the detected intensity (luminance) of the return light L2 from the target object T0. Note that a pinhole, a slit, or the like may be disposed at a position conjugate with the focusing point of the objective lens 5, and the detectors 6A and 6B may detect the return light L2 that has passed through the pinhole, the slit, or the like.

Each of the detectors 6A and 6B may be a sensor including a plurality of pixels (light receiving elements) arranged in one direction. Each of the detectors 6A and 6B is, for example, a line sensor including 1,024 pixels. In this case, the illumination light L1 is formed in a line shape through a slit (not shown). The pixels of each of the detectors 6A and 6B are arranged along a direction corresponding to the irradiation region of the line-shaped illumination light L1. A CCD (Charge Coupled Device) or a CMOS (Complementary Metal Oxide Semiconductor) sensor is used as each of the detectors 6A and 6B. Each of the pixels outputs a detection signal DET1 corresponding to the amount of light received in the pixel. The detection signals DET1 and DET2 are input to a processing device (not shown).

The processing device includes a processor, a memory, and a storage device as its components (not shown). In the storage device, a program for causing a computer to perform the measuring method according to the first embodiment is stored. This processor can load the program from the storage device onto the memory, and execute the loaded computer program. In this way, the processor implements the functions of the acquisition unit, the measuring unit, the output unit, and the like. The operation of each function will be described below in detail.

Note that the components of the processing device may be implemented by dedicated hardware. Further, some or all of the components may be implemented, for example, by a general-purpose or dedicated circuit, a processor, or a combination thereof. These components may be formed by a single computer chip or by a plurality of computer chips connected to each other through a bus. Some or all of the components of each unit may be implemented by a combination of the above-mentioned circuitry or the like and a program(s). Further, for the processor, a CPU (Central Processing Unit), a GPU (Graphics Processing Unit), or the like may be used.

In the above-described examples, the program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disk (DVD), a Blu-ray (Registered Trademark) disc or other optical disc storages, a magnetic cassette, magnetic tape, and a magnetic disc storage or other magnetic storage devices. The program may be transmitted on various types of transitory computer readable media or communication media. By way of example rather than limitation, transitory computer readable media or communication media may include electrical, optical, acoustic, or other forms of propagation signals.

The measuring device 100 can enter (1) a preparation stage and (2) a measurement stage.

### Preparation Stage

In the preparation stage, a preparation sample T1 is used as the target object T0. At a predetermined position on the preparation sample T1, the measuring device 100 irradiates the preparation sample T1 with the illumination light L1 at a plurality of height positions different from each other. Therefore, the detector 6A detects, when the preparation sample T1 is irradiated with the illumination light L1 at a plurality of height positions different from each other, the return light L2 at the rear focal position (first position) in the image-forming optical system, and acquires first intensity information indicating a relationship between the height position and the first detected intensity at the rear focal position. Further, the detector 6B detects, when the preparation sample T1 is irradiated with the illumination light L1 at a plurality of height positions different from each other, the return light L2 at the front focal position (second position) in the image-forming optical system, and acquires second intensity information indicating a relationship between the height position and the second detected intensity at the front focal position. The first and second positions are different from the position conjugate with the focusing point (focal point FP2) by the image-forming optical system.

The acquisition unit acquires relationship information indicating a relationship between the height position and a parameter which is based on the comparison between the results of the detections of the return light L2 by the detectors 6A and 6B (i.e., the comparison between first intensity information and second intensity information). Note that the “height position” means a relative position between a specific point on the target object T0 (e.g., the surface at the measurement position) and the focusing point (focal point FP1) by the illumination optical system in the height direction. Note that the height direction may mean the optical axis direction of the objective lens 5, or may mean the normal direction of the main surface of the target object T0.

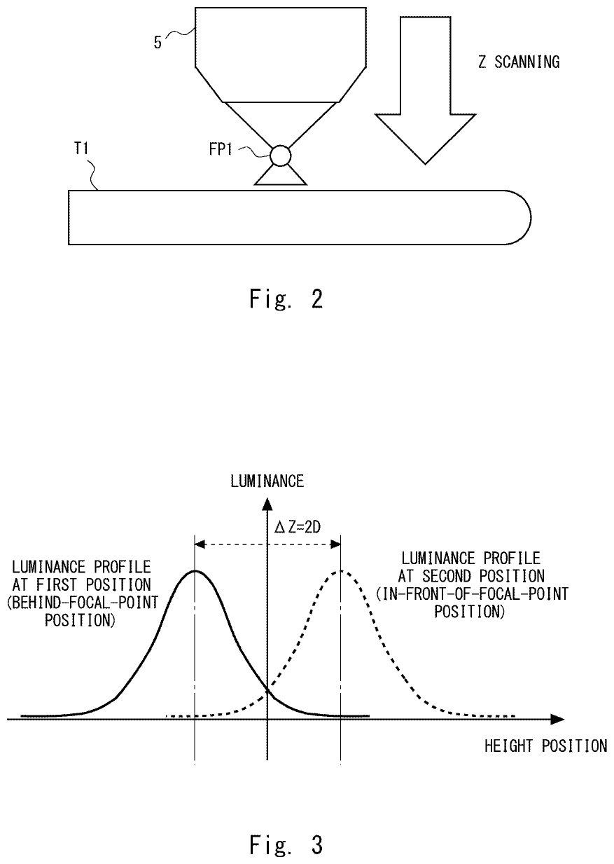

FIG. 2 is a diagram for explaining “Z scanning” in the preparation stage. The “Z scanning” refers to an operation in which the height position, which is the relative position between the preparation sample T1 and the focusing point (focal point FP1) by the illumination optical system in the height direction, is continuously changed. As shown in FIG. 2, in this operation, the height position is changed by changing (i.e., moving) the objective lens 5 in the Z-direction. For example, the focal point FP1 is moved upward and away from the preparation sample T1 by moving the objective lens 5 away from the preparation sample T1. Further, the focal point FP1 is moved downward and away from the preparation sample T1 by moving the objective lens 5 closer to the preparation sample T1. In this way, a plurality of detection signals DET1 and DET2 at a plurality of respective height positions are acquired.

Note that the parameter based on the comparison between the first intensity information and the second intensity information is a normalized error signal that is obtained by dividing a difference signal between the first detected intensity (detection signal DET1) and the second detected intensity (detection signal DET2) by the addition signal of these detected intensities. The error signal indicates the amount of displacement of the convergence position (focal point FP1) of the illumination light L1 on the preparation sample T1. The parameter (error signal) S is expressed by the below-shown expression.

S=(DET1−-DET2)/(DET1+DET2)

Note that the position at which the parameter S based on the comparison between the detection signals DET1 and DET2 becomes zero is the position at which the focal point FP1 of the objective lens 5 coincides with the preparation sample T1 (exact-focus position).

FIG. 3 schematically shows the relationship between the detected intensity (luminance) of the return light L2 and the height position (Z) acquired at the preparation stage. In FIG. 3, the horizontal axis indicates the height position, and the direction in which the objective lens 5 moves away from the preparation sample T1 (the direction in which the focal point FP1 moves upward and away from the preparation sample T1) corresponds to the positive side on the horizontal axis. Further, the vertical axis indicates the detected intensity (luminance) of the return light L2. The luminance profile (detection signal DET1) at the rear focal position is indicated by a solid line, and the luminance profile (detection signal DET2) at the front focal position is indicated by a broken line. This relationship information indicating the relationship between the height position and the detected intensity is also called an “I-Z curve”.

As shown in FIG. 3, the detected intensity has a peak when the “height position” is a specific height position. In the I-Z curve shown in FIG. 3, the detected intensity has a peak when the focal point FP2 coincides with the rear focal position, and also has a peak when the focal point FP2 coincides with the front focal position. Therefore, the detection signal DET1 has a peak on the negative side on the horizontal axis, and the detection signal DET2 at the front focal position has a peak on the positive side on the horizontal axis.

It is known that the characteristics of the I-Z curve depend on the wavelength of the illumination light L1 and the numerical aperture (NA) of the objective lens 5. The shorter the wavelength of the illumination light L1 is and the higher the numerical aperture of the objective lens 5 is, the steeper the rise and fall of the I-Z curve become. The wavelength of the illumination light L1 and the numerical aperture of the objective lens 5 are selected as appropriate in order to improve the sectioning performance in the Z direction.

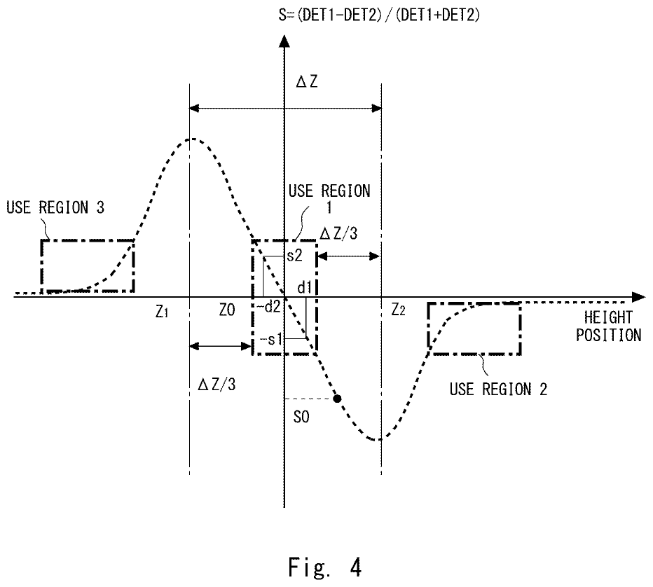

FIG. 4 shows the relationship between the parameter(S) based on the comparison between the first intensity information (detection signal DET1) and the second intensity information (detection signal DET2) shown in FIG. 3 and the height position (Z). A curve representing the relationship information at a predetermined position on the preparation sample T1 like the one described above is called an “S-Z curve”.

The acquisition unit may acquire, as the above-described relationship information, a relationship between a plurality of height positions and a parameter in a range of height positions between the height position Z₁ at which the first detected intensity has a peak and the height position Z₂ at which the second intensity has a peak. That is, the relationship information may be an S-Z curve in the range between two dash-dot lines in FIG. 4. The relationship information acquired by the acquisition unit shows such a relationship that the parameter S decreases as the height position increases (i.e., as the objective lens 5 moves away from the preparation sample T1).

Since the S-Z curve acquired as the relationship information is monotonically decreasing as described above, the parameter S corresponds to the height position in a one-to-one manner. Therefore, when the detection signals DET1 and DET2 are acquired in the measurement stage, one piece of height information can be specified. In the first embodiment, it is possible to convert the height position of the objective lens 5 into surface height information thereof based on the rear focal position detected intensity and the front focal position detected intensity of each measurement position on the measurement surface of the test sample T2.

Note that the optical distance between the rear focal position (first position) and the front focal position (second position) is referred to as a first optical distance ΔZ. When the first optical distance ΔZ is too large, the two I-Z curves shown in FIG. 3 are away from each other, so that the luminance change that occurs when the height position is changed becomes small. On the other hand, when the first optical distance ΔZ is too small, the difference between the two I-Z curves becomes small. Therefore, the change in the parameter S with respect to the change in the height position becomes small, thus making it difficult to accurately determine the surface height of the test sample T2. Therefore, the first optical distance ΔZ is preferably a distance roughly twice the depth of focus D (hereinafter also referred to as the focal depth D) of the image-forming optical system.

Further, the relationship information is preferably a relationship (S-Z curve) between a plurality of height positions and the parameter S, in a range of height positions including a height position separated from the height position Z₁ at which the first intensity has a peak by a distance equivalent to one third of the first optical distance ΔZ and a height position separated from the height position Z₂ at which the second intensity has a peak by a distance equivalent to one third of the first optical distance ΔZ out of a range of height positions between the height position Z₁ at which the first detected intensity has a peak and the height position Z₂ at which the second intensity has a peak.

For example, in the S-Z curve shown in FIG. 4, a use region 1 enclosed with a broken-line frame can be used as the relationship information. In this way, a steeper S-Z curve can be used as the relationship information, so that the height information can be accurately obtained. Note that the height information can also be obtained by using an S-Z curve in a region outside the above-described use region 1 as long as this region is within the range of height positions between the height position Z₁ at which the first detected intensity has a peak and the height position Z₂ at which the second intensity has a peak.

As described above, when each of the detectors 6A and 6B has a plurality of pixels, the relationship information between the height position and the detected intensity differs on a pixel-by-pixel basis due to the aberration. For example, it is known that among the plurality of pixels arranged in one direction in each of the detectors 6A and 6B, the I-Z curve by pixels disposed at or near the center is sharper than the I-Z curve by pixels disposed at or near both ends. Therefore, in this case, it is preferred that a plurality of pieces of relationship information corresponding to a plurality of respective pixels are acquired.

### Measurement Stage

In the measurement stage, a test sample T2 is used as the target object T0. For example, the test sample T2 could be the same object as the preparation sample T1. Note that the reflectance of the illumination light L1 of the test sample T2 may be roughly equal to the reflectance of the illumination light L1 of the preparation sample T1, or may be different therefrom.

The measuring device 100 sets the relative position between the test sample T2 and the focusing point (focal point FP1) by the illumination optical system in the height direction (referred to as the height position of the test sample T2) to a reference position Z0, which is a predetermined height position, and irradiates a plurality of measurement positions on the test sample T2 with the illumination light L1. The measuring unit can obtain surface height information at each of a plurality of measurement points on the test sample T2 by using a first detection result obtained by detecting the return light L2 at a third position in the image-forming optical system in the above-described state, a second detection result obtained by detecting the return light L2 at a fourth position a second optical distance away from the third position, and the relationship information.

Note that, for example, the rear focal position (first position) can be used as the third position, and the front focal position (second position) can be used as the fourth position. That is, the first position and the third position are the same position, and the second position and the fourth position are the same position. In this case, the second focusing point exists between the position conjugate with the first position and the position conjugate with the second position, and the second focusing point exists between the position conjugate with the third position and the position conjugate with the fourth position. Similarly to the first and second positions, the third position and the fourth position may be positions different from the position conjugate with the second focusing point by the image-forming optical system.

The optical distance between the first and second positions (referred to as a first optical distance) is roughly equal to the optical distance between the third and fourth positions (referred to as a second optical distance). That is, the second optical distance between the third and fourth positions is twice the focal depth (i.e., 2D). Note that as long as the first optical distance is equal to the second optical distance, the third position may be a position different from the first position, and the fourth position may be a position different from the second position. Either the third position or the fourth position may be a position conjugate with the second focusing point.

The result of the detection of the return light L2 by the detector 6A obtained when a plurality of measurement positions on the test sample T2 are irradiated with the illumination light L1 is the first detection result. Further, the result of the detection of the return light L2 by the detector 6B obtained when the plurality of measurement positions on the test sample T2 are irradiated with the illumination light L1 is the second detection result. The measuring unit calculates a measurement parameter Sm for obtaining surface height information from the first and second detection results. The measuring unit obtains, from the calculated measurement parameter Sm, height information corresponding thereto by using the relationship information. By obtaining height information at each of a plurality of measurement positions on the test sample T2, the measuring device 100 can measure irregularities on the measurement surface of the test sample T2.

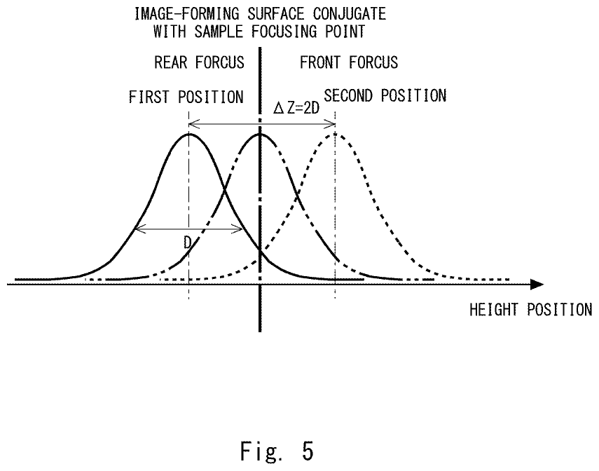

The second focusing point by the image-forming optical system coincides with the image-forming surface conjugate with the focusing point (focal point FP1) of the test sample T2. FIG. 5 shows the relationship between the I-Z curve on the image-forming surface conjugate with the sample focusing point and the I-Z curve at the first and second positions when the first position is the rear focal position and the second position is the front focal position. As described above, when the first position is the rear focal position and the second position is the front focal position, the image-forming surface conjugate with the sample focusing point is between the first and second positions. The S-Z curve acquired as the relationship information in this case is shown in the use region 1 in FIG. 4. As described above, by calculating the parameter S using the detected intensities at the rear focal position and at the front focal position, respectively, the S-Z curve acquired as the relationship information becomes steep, so that the height information can be accurately acquired.

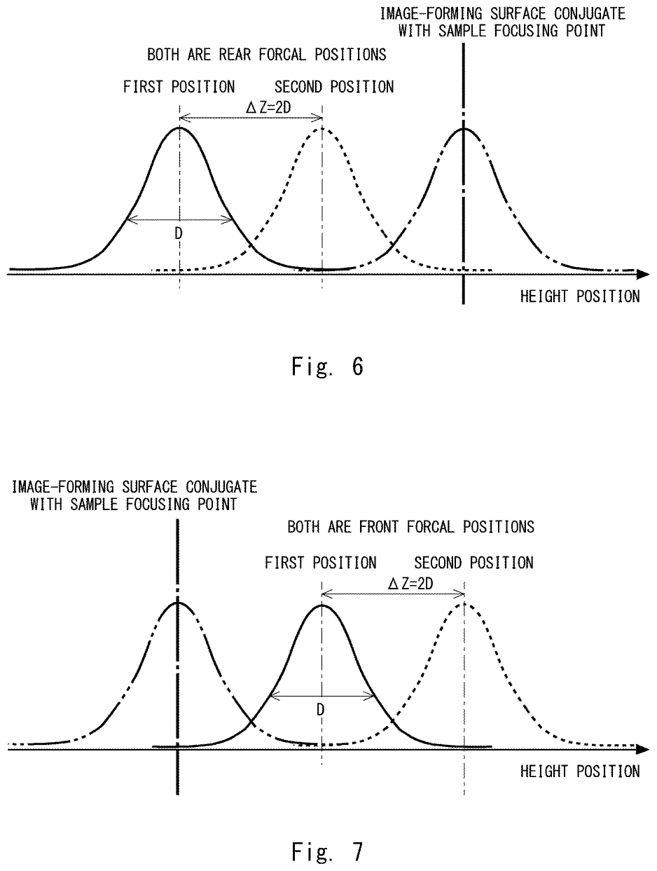

Note that both the first and second positions may be the rear focal position. FIG. 6 shows the relationship between the I-Z curve on the image-forming surface conjugate with the sample focusing point and the I-Z curve at the first and second positions when both the first and second positions are the rear focal position. As described above, even when both the first and second positions are the rear focal position, the parameter S for calculating the surface height information of the test sample T2 can be obtained. The S-Z curve acquired as the relationship information in this case is shown in a use region 2 in FIG. 4. Even when both the first and second positions are the rear focal position, it is possible to convert the change in the parameter S into a change in height based on the relationship information.

Further, both the first and second positions may be the front focal position. FIG. 7 shows the relationship between the I-Z curve on the image-forming surface conjugate with the sample focusing point and the I-Z curve at the first and second positions when both the first and second positions are the front focal position. As describe above, even when both the first and second positions are the front focal position, the parameter S for calculating the surface height information of the test sample T2 can be obtained. The S-Z curve obtained as the relationship information in this case is shown in a use region 3 in FIG. 4. Even when both the first and second positions are the front focal position, it is possible to convert the change in the parameter S into a change in height based on the relationship information.

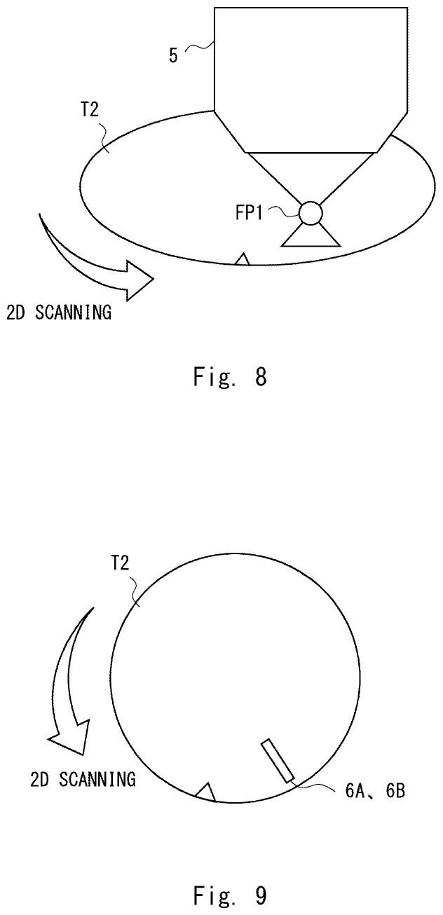

FIG. 8 schematically shows how two-dimensional scanning (2D scanning) is performed on the test sample T2 by the illumination light L1 on the XY plane. FIG. 9 schematically shows how a relative position of the region on the test sample T2 of which an image is formed in the detectors 6A and 6B is changed when two-dimensional scanning is performed as shown in FIG. 8. In the example shown in FIGS. 8 and 9, the test sample T2 is placed on a rotating stage. As described above, in the measurement stage, the height position of the test sample T2 is set to the predetermined reference position Z0. Therefore, as shown in FIG. 8, the two-dimensional scanning on the test sample T2 by the illumination light L1 is performed by rotating the stage in the circumferential direction without moving the objective lens 5 of which the position has been adjusted so that the height position of the test sample T2 coincides with the predetermined reference position Z0.

The return light L2 from the test sample T2 is detected by the detectors 6A and 6B each including a plurality of pixels arranged in one direction. By rotating the stage in the circumferential direction, the test sample T2 moves in such a manner that the test sample T2 moves in the direction (Y-axis direction) perpendicular to the direction (X-axis direction) in which the plurality of pixels are arranged with respect to the region of which an image is formed in the detectors 6A and 6B. Based on the above-described principle, the measuring unit can obtain, for each of the pixels, height information based on the measurement parameter Sm of the pixel by using the piece of relationship information corresponding to the pixel. As described above, according to the first embodiment, it is possible to measure irregularities on the measurement surface of the test sample T2 in a short time by just performing the two-dimensional scanning in the XY directions without performing Z scanning for the plurality of measurement positions.

The output unit outputs an image in which height information at each measurement position on the test sample T2 is expressed in gradation, for example, on an XY plane in which positions of a plurality of pixels of the detectors 6A and 6B are represented by X coordinates and a plurality of positions in the scanning direction are represented by Y coordinates. As described above, by expressing irregularities on the measurement surface of the test sample T2 in gradation, the surface shape of the test sample T2 can be recognized more intuitively, so that the presence/absence of an abnormality can be easily determined.

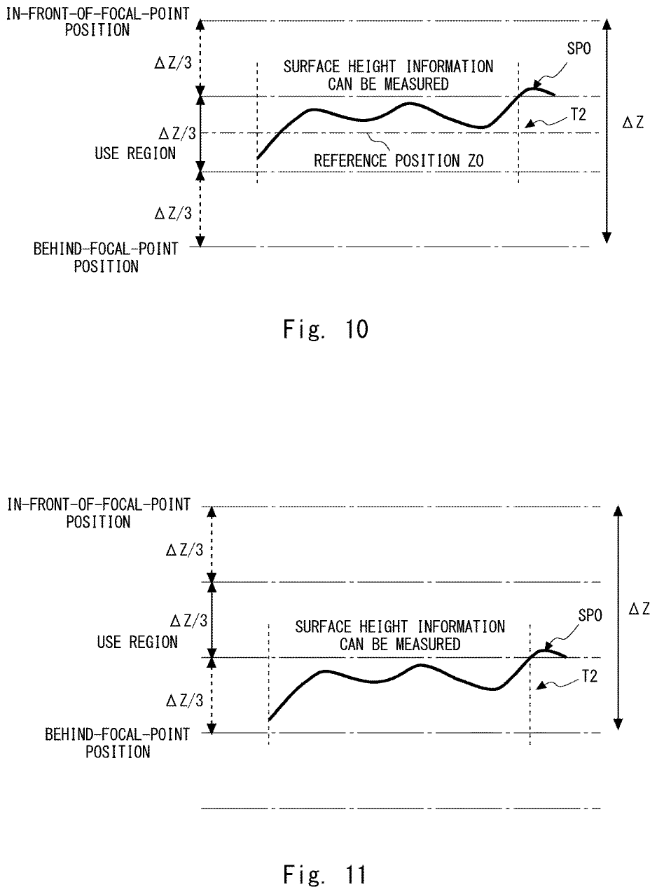

FIG. 10 is a graph for explaining the relationship between the measurement surface of the test sample T2 and the focusing point (image-forming surface) of the image-forming optical system when the use region 1 shown in FIG. 4 is used as the relationship information. For the sake of explanation, the focusing point of the image-forming optical system is indicated by a dash-dot line on the test sample T2 shown in FIG. 10. The lower side of FIG. 10 is the rear focal position and the upper side is the front focal position. The optical distance between the rear focal position and the front focal position is represented by ΔZ. The use region used as the relationship information is a region of one third of ΔZ at the center between the rear focal position and the front focal position.

In FIG. 10, when the focusing point of the return light L2 from the measurement surface of the test sample T2 is within the use region 1, the measurement parameter Sm has a value that falls within the use region 1 shown in FIG. 4. The surface height information of the measurement surface of the test sample T2 between two broken lines in FIG. 10 can be measured by using the relationship information.

Specifically, when the value S (measurement parameter Sm) based on the comparison between the first and second detection results at a certain measurement position is zero, the surface height of this measurement position coincides with the reference position Z0. Further, when the value S (measurement parameter Sm) based on the comparison between the first and second detection results at a certain measurement position is −s1, the surface height of this measurement position is a distance d1 away from the reference position Z0 and is the distance dl larger than the reference position Z0 (see FIG. 4). Further, when the value S based on the comparison between the first and second detection results at a certain measurement position is +s2, the surface height of this measurement position is different from the reference position Z0 by a distance d2 and is the distance d2 smaller than the reference position Z0 (see FIG. 4).

The processing device may further include a determination unit for determining whether the value based on the comparison between the first and second detection results exceeds the range of the relationship information. For example, there are cases where the measurement parameter Sm calculated from the detection signals DET1 and DET2 of the test sample T2 exceeds the value of the use region. For example, at a measurement position SP0 in FIG. 10, the focusing point of the return light L2 is outside the range of the use region 1. Since the focusing point of the return light L2 from the measurement position SP0 is shifted from the use region 1 toward the front focal position, the measurement parameter Sm has a value indicated by S0 in FIG. 4. In this case, since the measurement parameter Sm exceeds the use range, the measuring unit cannot obtain the height information at the measurement position SP0.

Therefore, when the determination unit determines that the measurement parameter Sm exceeds the predetermined threshold (use region) (affirmative determination), the measuring unit may regard it as a measurement error and stop the calculation of the height information upon and after the affirmative determination. Further, when the determination unit affirmatively determines that the measurement parameter Sm exceeds the predetermined threshold (use region), the position control unit can control the height position of the test sample T2 at the time of the affirmative determination so as to move the height position of the test sample T2 from the reference position along the optical axis direction of the illumination light L1 by a distance equivalent to one third of the first optical distance so that the focusing point of the return light L2 of the test sample T2 is positioned within the use region. In this way, as shown in FIG. 11, the focusing point of the return light L2 from the measurement position SP0 on the test sample T2 is positioned within the use region 1, so that the height information at the measurement position SP0 can be obtained.

In general, when a three-dimensional shape is measured with a confocal microscope, it is necessary to repeatedly perform Z scanning for a plurality of measurement positions.

In contrast, according to the embodiment, when the measurement parameter Sm is within the use region, the irregularities on the measurement surface of the test sample T2 can be measured just by performing two-dimensional scanning in the XY directions without performing Z scanning for a plurality of measurement positions. On the other hand, when the measurement parameter Sm is outside the use region, the height position of the test sample T2 is moved from the reference position along the optical axis direction of the illumination light L1, and then two-dimensional scanning is performed in the XY directions in a similar manner. By connecting a plurality of pieces of height information of the test sample T2 measured by changing the height position of the test sample T2 as described above, it is possible to measure the irregularities on the measurement surface of the test sample T2. As described above, it is possible to increase the scanning width (the moving width of the height position) in the Z direction compared with that in the ordinary three-dimensional shape measurement, and thereby to shorten the measurement time.

The above description is given using an example case where the first position is the rear focal position and the second position is the front focal position, and the S-Z curve acquired as the relationship information is used as the use region 1 shown in FIG. 4. Similar processing can be applied to a case where both the first and second positions are the rear focal position and the relationship information is used as the use region 2, and a case where both the first and second positions are the front focal position and the relationship information is used as the use region 3.

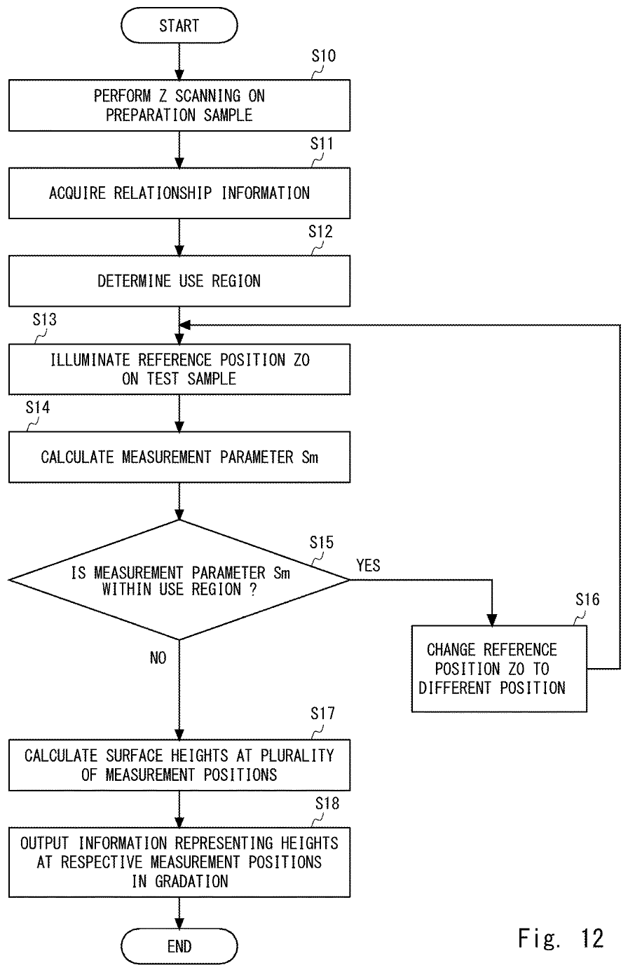

FIG. 12 is a flowchart for explaining a measurement method according to the first embodiment. In this measurement method, the above-described measuring device 100 including the illumination optical system and the image-forming optical system is used. The measuring device 100 first performs Z scanning for a preparation sample T1 (Step S10). Specifically, the measuring device 100 changes the height position, which is the relative position between the preparation sample T1 and the focusing point (focal point FP1) in the height direction at a predetermined position on the preparation sample T1. Then, the measuring device 100 detects, when the preparation sample T1 is irradiated with the illumination light L1 at a plurality of height positions different from each other, a detection signal DET1 of the return light L2 at the detector 6A and a detection signal DET2 thereof at the detector 6B, respectively.

In this way, as shown in FIG. 3, the measuring device 100 acquires first intensity information indicating the relationship between the height position and the first detected intensity at the rear focal position (first position), and acquires second intensity information indicating the relationship between the height position and the second detected intensity at the front focal position (second position). In this way, relationship information indicating the relationship between the height position and the parameter S based on the comparison between the first intensity information and the second intensity information is acquired (Step S11). For example, the S-Z curve shown in FIG. 4 is obtained as the relationship information. Further, in order to improve the accuracy of the detection, a use region used for obtaining the surface height in the S-Z curve shown in FIG. 4 is determined (Step S12). Steps S10 to S12 represent processes performed by the measuring device 100 at the preparation stage.

After that, the measuring device 100 proceeds to processes in the test stage. Firstly, the measuring device 100 uses the height position of the test sample T2 as the reference position Z0, i.e., as a predetermined height position, and irradiates the measurement position on the test sample T2 with the illumination light L1 (Step S13). The measuring device 100 can irradiate a plurality of measurement positions on the test sample T2 with the illumination light L1 by two-dimensionally scanning the test sample T2 with the illumination light L1. In this way, a first detection result (detection signal DET1) and a second detection result (detection signal DET2) are obtained by the return light obtained when a plurality of measurement positions on the test sample T2 are irradiated with the illumination light L1.

Then, the measuring device 100 calculates a measurement parameter Sm from the first and second detection results (Step S14). Note that as an optional step, the measuring device 100 determines whether or not the measurement parameter Sm exceeds the use region (Step S15). Note that when it is obvious that the measurement parameter Sm does not exceed the use region, the step S15 may be omitted (i.e., skipped). When it is determined that the measurement parameter Sm exceeds the threshold (Step S15, YES), the measuring device 100 controls the height position so that a height position different from the reference position at the time of the affirmative determination is set as a new reference position (Step S16), and the process returns to the step S13.

On the other hand, when it is determined that the test detection result does not exceed the threshold (Step S15, NO), the measuring device 100 can calculate surface height information at the plurality of measurement positions based on the measurement parameter S obtained when the plurality of measurement positions are irradiated with the illumination light L1 by using the relationship information determined in the step S12 (Step S17). Then, if necessary, the measuring device 100 can output information in which heights at respective measurement positions on the test sample T2 are expressed in gradation (Step S18).

### Second Embodiment

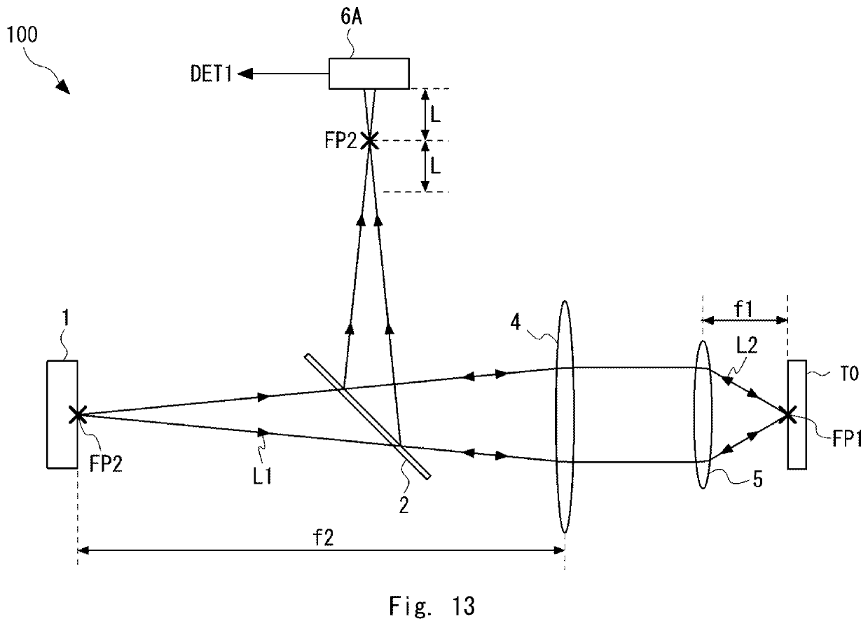

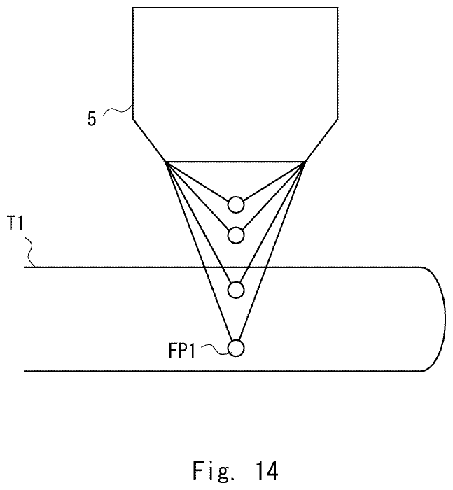

FIG. 13 schematically shows a configuration of a measuring device according to a second embodiment. In the second embodiment, one detector 6A is used as the detection unit. The measuring device 100 shown in FIG. 13 includes a light source 1, a beam splitter 2, a lens 4, an objective lens 5, and a detector 6A.

In the second embodiment, the one detector 6A further includes a variation control unit for varying the second focusing point by the image-forming optical system along the optical axis direction of the return light L2 so that the return light is detected at the rear focal position (first position) and at the front focal position (second position), respectively. For example, the variation control unit moves the detector 6A between the rear focal position and the front focal position.

For example, the detector 6A is first positioned at the rear focal position and acquires first detected intensity at the rear focal position. FIG. 13 shows a state in which the detector 6A is positioned at the rear focal position. Then, the detector 6B is moved from the rear focal position to the front focal position, and then acquires the second detected intensity at the front focal position. The measuring device 100 can calculate the above-described parameter S by using the acquired first detected intensity and second detected intensity. Note that the rest of the configuration is similar to that of the measuring device according to the first embodiment, and has already been described in the above description.

As described above, in the second embodiment, it is possible to acquire the detected intensity at the rear focal position and at the front focal position by using the one detector 6A, and thereby to make the configuration of the device simpler. Note that the rear focal position and the front focal position can be realized, instead of or in addition to moving the detector 6A as described above, by shifting the focusing point of the return light L2 to the sensor surface of the detector 6A. The focusing point of the return light L2 can be changed, for example, by driving the variable focus optical element of the illumination optical system such as the objective lens 5. The variable focus optical element will be described later.

### Third Embodiment

A measuring device according to a third embodiment will be described. The position control units described in the first and second embodiments are not limited to the above-described examples as long as the relative position between the target object T0 and the focusing point by the illumination optical system in the height direction can be changed. In the measuring device according to the third embodiment, the illumination optical system includes a variable focus optical element, and the position control unit changes the relative position between the target object T0 and the focusing point (focal point FP1) of the illumination optical system in the height direction by driving the variable focus optical element of the illumination optical system.

The variable focus optical element may be a combination of a plurality of mirrors, a combination of a plurality of lenses, or a single lens of which the focal length can be changed by changing its shape. The variable focus optical element may include the objective lens 5. The position control unit changes the focusing point (focal point FP1) of the illumination optical system by changing the position of at least one of the plurality of lenses or mirrors, or changing the shape of the variable focus lens.

FIG. 14 is a schematic diagram showing changes in the focal point FP1 in the measuring device according to the third embodiment. The measuring device according to the third embodiment irradiates the preparation sample T1 with the illumination light at a plurality of height positions different from each other by changing the position of the focal point FP1 of the objective lens 5 while fixing the relative position between the target object T0 and the objective lens 5 in the height direction.

Note that the direction in which the focal point FP1 approaches the objective lens 5 in FIG. 14 corresponds to the positive side on the horizontal axis in the graph shown in FIG. 3. That is, in the measuring device according to the third embodiment, increasing the “height position” (increasing the relative position between the target object T0 and the focusing point (focal point FP1) by the illumination optical system in the height direction) corresponds to moving the focal point FP1 closer to the objective lens 5. On the other hand, in the measuring device according to the third embodiment, decreasing the “height position” (decreasing the relative position between the target object T0 and the focusing point (focal point FP1) by the illumination optical system in the height direction) corresponds to moving the focal point FP1 further away from the target objective lens 5. The other components/structures are similar to those of the measuring device according to the first embodiment and have already been described in the description above.

Note that by changing the focusing point (focal point FP1) of the illumination optical system by the above-described variable focus element, the front focal position and the rear focal position described in the second embodiment can be changed.

Although the present disclosure has been described with reference to embodiments, the present disclosure is not limited to the embodiments described above. Various modifications that can be understood by those skilled in the art may be made to the structure and details of the present disclosure within the scope of the present disclosure. Then, the embodiments may be combined with one another as appropriate.

The drawings are merely examples for describing one or more embodiments. Each drawing is not associated with only one particular embodiment, but may be associated with one or more other embodiments. As will be understood by those skilled in the art, various features and steps described above with reference to any one of the drawings may be combined with features or steps shown in one or more of the other drawings in order to create, for example, an embodiment that is not explicitly shown nor described herein. Not all of the features or steps shown in any one of the drawings in order to describe an example embodiment are indispensable, and some of the features or steps may be omitted. The order of the steps shown in any one of the drawings may be changed as appropriate.

The first and second embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A measuring device comprising:
an illumination optical system configured to apply illumination light to a target object;
an image-forming optical system configured to concentrating return light from the target object based on the illumination light;
a position control unit configured to control a height position, the height position being a relative position between the target object and a first focusing point of the illumination light on the target object by the illumination optical system in a height direction;
a detection unit configured to detect, when a preparation sample is irradiated with the illumination light at a plurality of height positions different from each other at a predetermined position of the preparation sample, the return light, at a first position in the image-forming optical system and at a second position a first optical distance away from the first potion, and acquire first intensity information indicating a relationship between the height position and first detected intensity at the first position and second intensity information indicating a relationship between the height position and second detected intensity at the second position, in which the preparation sample is the target object;
an acquisition unit configured to acquire relationship information indicating a relationship between the height position and a parameter based on a comparison between the first intensity information and the second intensity information; and
a measuring unit configured to obtain surface height information at a plurality of measurement points on a test sample by using a first detection result obtained by detecting, when the test sample is irradiated with the illumination light at a plurality of height positions while setting a height position for the test sample to a predetermined reference position, the return light at a third position in the image-forming optical system, a second detection result obtained by detecting the return light at a fourth position a second optical distance away from the third position, and the relationship information, in which the test sample is the target object.

2. The measuring device according to claim 1, wherein the first optical distance is roughly equal to the second optical distance.

3. The measuring device according to claim 2, wherein the first position, the second position, the third position, and the fourth position are all different from a position conjugate with the second focusing point by the image-forming optical system.

4. The measuring device according to claim 3, wherein
the second focusing point exists between a position conjugate with the first position and a position conjugate with the second position, and
the second focusing point exists between a position conjugate with the third position and a position conjugate with the fourth position.

5. The measuring device according to claim 2, wherein the first position and the third position are the same position, and the second position and the fourth position are the same position.

6. The measuring device according to claim 2, wherein each of the first and second optical distances is roughly twice a depth of focus of the image-forming optical system.

7. The measuring device according to claim 2, wherein the relationship information is a relationship between a plurality of height positions and the parameter in a height range between a height position at which the first detected intensity has a peak and a height position at which the second detected intensity has a peak.

8. The measuring device according to claim 7, wherein the relationship information is a relationship between a plurality of height positions and the parameter in a height range including a height position separated from the height position at which the first detected intensity has a peak by a distance equivalent to one third of the first optical distance and a height position separated from the height position at which the second detected intensity has a peak by a distance equivalent to one third of the first optical distance.

9. The measuring device according to claim 7, further comprising a determination unit configured to determine whether or not a value based on a comparison between the first and second detection results exceeds a range of the relationship information, wherein
when the determination unit makes an affirmative determination, the position control unit controls the height position of the test sample so as to move the height position of the test sample at the time of the affirmative determination from the reference position along an optical axis direction of the illumination light by a distance equivalent to one third of the first optical distance.

10. The measuring device according to claim 1, wherein
the detection unit includes a plurality of pixels,
the acquisition unit acquires a plurality of pieces of relationship information each of which corresponds to a respective one of the plurality of pixels, and
the measuring unit obtains the surface height information by using the pieces of relationship information corresponding to the respective pixels.

11. The measuring device according to claim 10, wherein
the detecting unit includes a plurality of pixels arranged in one direction, and
the measuring device further comprises a scanning control unit configured to move a region on the test sample of which an image is formed by the detection unit relative to the test sample so that the detection unit moves with respect to the test sample in a scanning direction perpendicular to the one direction.

12. The measuring device according to claim 11, wherein
the measuring unit acquires the surface height information for each of the measurement positions each of which corresponds to a position of a respective one of the plurality of pixels, and
the measuring device further comprises an output unit configured to output an image in which the surface height information of each of the measurement positions is expressed in gradation on a coordinate plane in which positions on the test sample corresponding to the positions of the plurality of pixels arranged in the one direction are represented by first coordinates and positions on the test sample in the scanning direction are represented by second coordinates.

13. The measuring device according to claim 1, wherein the detection unit comprises:
a first detection unit configured to detect the return light at the first position; and
a second detection unit configured to detect the return light at the second position, the second detection unit being different from the first detection unit.

14. The measuring device according to claim 1, wherein
the detection unit comprises one detection unit, and
the detection unit further comprises a variation control unit configured to vary the second focusing point by the image-forming optical system along an optical axis direction of the return light so as to detect the return light at the first and second positions, respectively.

15. The measuring device according to claim 1, wherein the test sample is the same object as the preparation sample.

16. A measuring method comprising:
by using a measuring device including an illumination optical system configured to apply illumination light to a target object, and an image-forming optical system configured to concentrating return light from the target object based on the illumination light,
controlling a height position, the height position being a relative position between the target object and a first focusing point of the illumination light on the target object by the illumination optical system in a height direction;
detecting, when a preparation sample is irradiated with the illumination light at a plurality of height positions different from each other at a predetermined position of the preparation sample, the return light at a first position in the image-forming optical system and at a second position a predetermined optical distance away from the first potion, and acquiring first intensity information indicating a relationship between the height position and first detected intensity at the first position and second intensity information indicating a relationship between the height position and second detected intensity at the second position, in which the preparation sample is the target object;
acquiring relationship information indicating a relationship between the height position and a parameter based on a comparison between the first intensity information and the second intensity information; and
obtaining surface height information at a plurality of measurement points on a test sample by using a first detection result obtained by detecting, when the test sample is irradiated with the illumination light at a plurality of height positions while setting a height position for the test sample to a predetermined reference position, the return light at a third position in the image-forming optical system, a second detection result obtained by detecting the return light at a fourth position a predetermined optical distance away from the third position, and the relationship information, in which the test sample is the target object.
